(19) United States
(12) Patent Application Publication
(10) Pub. No.: US 2020/0399957 A1
(43) Pub. Date: Dec. 24, 2020

(54) ADJUSTABLE WIDTH ROLLER BLIND ASSEMBLY

(71) Applicant: Fourds Limited, Magherafelt (GB)

(72) Inventors: Cormac DIAMOND, Magherafelt (GB); Kevin MCCULLAGH, Magherafelt (GB); Kathryn BLEAKLEY, Magherafelt (GB); Patrick MCGIRR, Magherafelt (GB)

(21) Appl. No.: 16/970,142

(22) PCT Filed: Feb. 6, 2019
(86) PCT No.: PCT/EP2019/052889

§ 371 Date: Aug. 14, 2020

(30) Foreign Application Priority Data
Feb. 16, 2018 (GB) 1802538.7

(51) Int. Cl. E06B 9/44

(52) U.S. Cl. CPC E06B 9/44; E06B 2009/407

(57) ABSTRACT

A roller blind assembly having a roller with a longitudinal axis, and a generally rectangular screen formed from a flexible sheet material with an upper marginal edge securable to the roller. The roller has first and second roller sections which are substantially cylindrical and axially aligned, and an intermediate section located between and telescopically received within the first and second roller sections, allowing adjustment of the roller length. The upper marginal edge is provided with a releasable fastening device having a substantially rigid elongate member adapted to engage the first and second roller sections, bridging the gap therebetween by the intermediate section, when the screen is attached to the roller to support the screen when it is wound onto the roller releasably attaching the screen to the first and second roller sections.

### FIELD OF THE INVENTION

This invention relates to an adjustable width roller blind assembly for a window or door.

### BACKGROUND OF THE INVENTION

Windows are typically provided with screens fitted to the inside of the frame of the window opening, typically fixed to the upper face of the window opening or between the sides of the window opening adjacent the upper face thereof, for selectively obscuring the window. In the case of a roller blind, a roller is mounted at an upper side of the frame around which a suitable screen is wound. The screen may be lowered and raised by rotating the roller. The lower end of the screen may be attached to a relatively heavy bar such that the screen hangs from the roller under gravity. The roller, upon which the screen is wound is typically located within an elongate cassette adapted to be mounted at an upper side of a window opening.

It has been necessary for manufacturers of roller blinds to provide products of numerous different widths to accommodate various sizes of window. Alternatively, roller blinds can be custom made by the manufacturer according to particular window dimensions. However, this can be a time consuming and costly process, particularly in the case of homes containing windows of a variety of different sizes. In addition, in the event of inaccurate measurements the product must be returned to the manufacturer for recutting, if possible. Alternatively the user may be required to use cutting tools to cut one lateral side of the screen and/or the roller to fit the size of the window.

U.S. Pat. No. 4,539,238 addressed the need for roller blinds which can be manufactured in a single standard size and adjusted by the consumer in the home to fit windows of varying dimensions. This patent describes a tear-away window shade having a multiplicity of elongate fabric strips of substantially equal length disposed laterally adjacent to each other in substantially the same plane. The roller upon which the screen is mounted takes the form of a pair of telescoping cylinders for modifying the length of the roller to suit the width of the window opening. The problem with this arrangement is that the telescoping cylinders forming the roller have, by necessity to permit one to fit within the other, slightly different overall diameters, leading to the creation of a step or discontinuity at the intersection between the two cylinders which can cause the screen to droop over the larger cylinder onto the smaller cylinder, making the screen unattractive in appearance and causing wrinkling of the shade down its middle and problems when winding the screen onto the roller during raising and lowering of the screen.

GB 2,544,545 describes an adjustable width roller blind wherein the roller comprises substantially cylindrical and axially aligned first and second roller sections, said first roller section incorporating a plurality of first fingers extending axially therefrom towards the second roller section, said second section incorporating a plurality second fingers extending axially therefrom towards the first roller section, wherein the second fingers are circumferentially offset from said first fingers such that each first finger of the first roller section is receivable between a respective pair of second fingers of said second roller section such that the overall length of the roller is adjustable by adjusting the extent to which the first and second fingers, and thus the first and second roller sections, overlap one another, said first and second roller sections having a substantially equal and constant outer diameter such that the roller has a substantially uniform outer diameter over its length. While this arrangement provides an adjustable width roller having a substantially smooth and uniform outer surface regardless of the extension of the roller, helping to prevent drooping or wrinkling of the screen material when wound thereon, it requires and costly and complicated manufacturing process and the interlocking fingers of the first and second sections of the roller are prone to damage and/or jamming

It is an object of this invention to provide an improved roller blind assembly including an adjustable width roller which is easier for the consumer to size and cheap to produce while still avoiding drooping and wrinkling of the screen material as it is wound onto the roller.

### SUMMARY OF THE INVENTION

According to a first aspect of the present invention there is provided an adjustable width roller blind assembly comprising a roller having a longitudinal axis, a generally rectangular screen formed from a flexible sheet material having an upper marginal edge securable to the roller, wherein the roller comprises substantially cylindrical and axially aligned first and second roller sections, and an intermediate section located between and telescopically received within the first and second roller sections to permit adjustment of the length of the roller by adjusting the overlap between the first and second roller sections and the intermediate section, wherein an upper marginal edge of the screen is provided with a releasable fastening device adapted to releasably attach the screen to the first and second roller sections, said releaseable fastening device comprising a substantially rigid elongate member adapted to engage the first and second roller sections, bridging the gap therebetween by the intermediate section, when the screen is attached to the roller.

Preferably the elongate member defining said fastening device is formed from a substantially rigid material that resists bending, such as rigid plastic or metal. Preferably the elongate member is shaped to resist bending.

In a preferred embodiment the first and second sections of the roller may be provided with an elongate slot or channel extending substantially over the entire length of the first and second sections of the roller and parallel to the axis of the roller, said fastening device comprising an elongate strip receivable within said elongate slot or channel.

Preferably the elongate slot or channel extends substantially tangentially to the outer surface of the first and second sections of the roller for receiving a least a portion of said elongate strip defining the fastening device.

The shape and dimensions of the slot or channel and that of the elongate strip may be such that, in use, when the elongate strip defining the fastening device is inserted into the slot or channel to secure the screen to the roller, the resulting assembly presents a circular cross section of substantially constant radius. The elongate strip defining the fastening device may comprise a base portion adapted to lie against or within a seat formed in the outer surface of both the first and second roller sections adjacent said slot or channel and a terminal portion shaped to be received within the elongate slot or channel of the first and second roller sections, the base portion having a curved outer face defining a continuation of the outer surface of the roller.

A portion of said slot or channel may be defined by a lip extending in a direction substantially tangential to the outer surface of the first and second roller sections, such that said terminal portion of the fastening device can be received beneath said lip. Preferably an outer face of said lip defines a portion of the outer surface of the roller.

One of said seat formed in the outer surface of both the first and second roller sections and said elongate strip may include a recess and the other of said seat and said elongate strip may include a projection cooperating with said recess to retain the elongate strip defining the fastening device within the slot or channel.

The first, second and/or intermediate sections of the roller may be provided with markings to enable the overall length of the roller to be determined therefrom.

The first and second sections of the roller may incorporate formations engaging cooperating formations on the intermediate section to prevent rotation of the first and second sections with respect to the intermediate section and thereby with each other. Said cooperating formations may comprise at least one elongate channel formed in an outer surface of the intermediate section within which is received a cooperating ridge or rib extending from an inner surface of each of the first and second sections of the roller.

Preferably a locking device is provided for locking the positions of the first and second roller sections with respect to the intermediate section to fix the length of the roller. In one embodiment said locking device may comprise one or more apertures formed in the first and second roller sections and fasteners, such as screws, may be insertable through said apertures to engage the intermediate section. The fasteners may comprise self tapping screws.

To provide greater resistance to drooping or wrinkling of the screen when wound over the exposed portion of the intermediate section of the roller, an upper marginal portion of the screen may be formed from a material having a greater thickness and/or stiffness than the remainder of the screen, said releasable fastening device by which the screen is attached to the roller being provided on an upper marginal edge of said upper marginal portion of the screen. The upper marginal portion of the screen may have a length substantially equal to or greater than the outer circumference of the roller such that said upper marginal portion wraps at least once around the roller as the screen is wound onto the roller. The remainder of the screen may be releasably attached to a lower marginal edge of said upper marginal portion of the screen.

According to a further aspect of the present invention there is provided a method of installing a roller blind assembly in accordance with the first aspect of the invention to a window opening comprising the steps of fitting first and second mounting brackets to either side of the window opening, extending the first and second roller sections of the roller away from each other until the ends of the roller engage the first and second mounting brackets, providing a screen wherein an upper marginal edge of the screen is provided with a releasable fastening device in the form of a substantially rigid elongate member for releasably attaching the screen to the first and second roller sections and having a width substantially equal to the extended length of the roller and attaching the releasable fastening device of the screen to the roller such that the fastening device bridges any exposed region of the intermediate section of the roller between the first and second sections of the roller. The method may comprise the step of locking the first and second roller sections to the intermediate section to fix the length of the roller prior to attaching the screen thereto.

### BRIEF DESCRIPTION OF THE DRAWINGS

A roller blind assembly in accordance with an embodiment of the present invention will now be described, by way of example only, with reference to the accompanying drawings, in which:

FIG. 1 is a perspective view of a roller blind assembly in accordance with an embodiment of the present invention in an extended configuration;

FIG. 2 is a perspective view of the roller blind assembly of FIG. 1 in a retracted configuration;

FIG. 3 is an exploded view of the roller blind assembly of FIG. 1;

FIGS. 4 and 5 are exploded views of the roller blind assembly of FIG. 1 with the screen removed;

FIG. 6 is a further perspective view of the roller of the roller blind assembly of FIG. 1 with the screen removed; and

FIG. 7 is a detailed exploded view of one end of the roller blind assembly of FIG. 1.

### DETAILED DESCRIPTION OF THE DRAWINGS

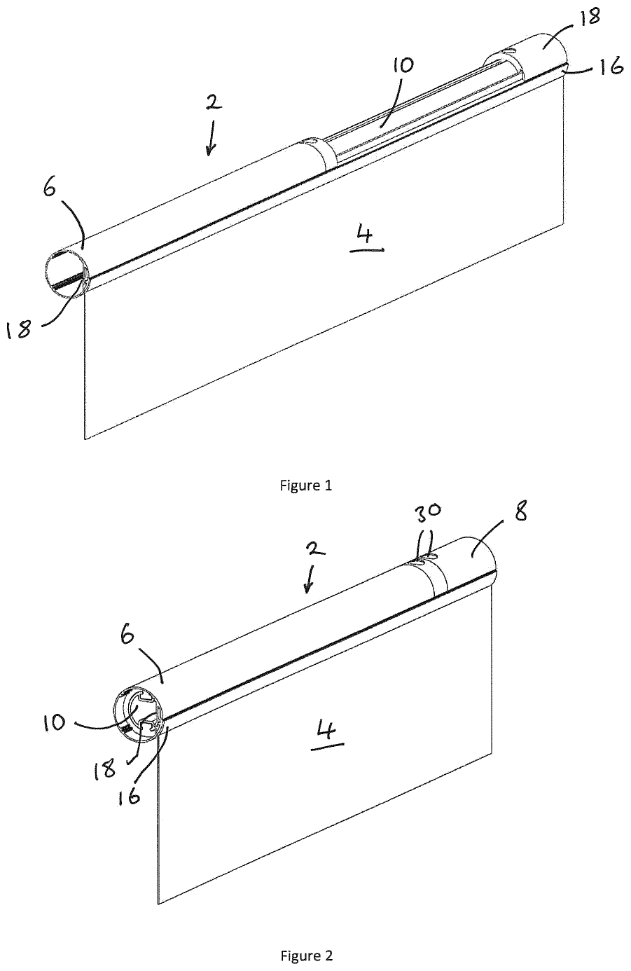

As illustrated in FIGS. 1 and 2, a roller blind assembly in accordance with a first embodiment of the present invention comprises an elongate roller 2 adapted to be mounted in an upper side of a window opening between a pair of mounting brackets (not shown) and a screen 4 releasably attached to the roller 2.

The mounting brackets may be of the type disclosed in EP 2652229, incorporated herein by reference, wherein the mounting brackets may be attached the sides of a window opening such that the roller may be engaged onto the mounting brackets to mount the support member in the window opening, wherein each mounting bracket comprises a first part attachable to a respective side of a window opening and a second part adapted to be mounted on the first part, said second part being adapted to engage a respective end of the roller, or an intermediate support member, wherein the second part of each mounting bracket is adapted to be mounted on the respective first part in a plurality of positions to enable the relative position of the second part of each mounting bracket to be adjusted with respective to the first part, in use, in a substantially vertical direction.

A fabric screen 4 is supported from the roller 2 such that the screen 4 can be raised or lowered by rotation of the roller 2 whereby the screen 4 becomes wrapped around the roller 2 to raise the screen 4 or unwrapped to lower the screen 4, as in known in the art. The roller 2 may be tensioned, for example by means of a spring, to bias the roller 2 in a winding direction whereby the screen 4 is biased towards a raised or open position with the screen 4 wound onto the roller 2. The roller 2 may be rotated by a manual operating mechanism, such as a pull cord or chain (not shown), or by a motorised drive to enable the screen 4 to be lowered and raised by rolling and unrolling the screen on the roller in known manner. A rod or bar (not shown) may be attached to a lower free edge of the screen 4 to maintain the screen 4 under tension.

As discussed above, it is desirable to enable the roller blind assembly to be adapted by the customer adjust the width of the screen to suit the specific window opening in which it is to be installed. The screen 4 can be provided to the customer having a custom made width to suit the window opening in which it is intended to be fitted. Alternatively, the screen 4 may be readily cut to adjust the overall width of the screen.

In order to facilitate adjustment of the width of the roller 2 by the customer, the roller 2 comprises substantially cylindrical and axially aligned first and second roller sections 6,8, and an intermediate section 10 arranged between and being telescopically received within the first and second roller sections, whereby that the overall length of the roller 2 is adjustable by adjusting the extent to which the first and second roller sections 6,8, telescopically overlap the intermediate section 10.

The intermediate section 10 incorporates axially extending channels 12 in its outer surface within which are slideably received inwardly projecting ribs 14 formed on the inner surface of the first and second roller sections 6,8 so that the first and second roller sections 6,8 can be axially adjusted with respect to the intermediate section 10 to vary the overall length of the roller 2 while preventing rotation of the first and second roller sections 6,8 with respect to the intermediate section 10.

The first and second roller sections 6,8 have a substantially equal and constant outer diameter such that the roller 2 has a substantially uniform outer diameter over its length, other than the exposed portion of the intermediate section 10. A tubular further roller section 25 may be attached to an outer end of one or both of the first and second roller section 6,8. In order to enable the roller 2 to be fitted to the mounting brackets axially extending mounting pins (not shown) may be provided at each end of the roller 2 to engage receiving aperture in the mounting brackets.

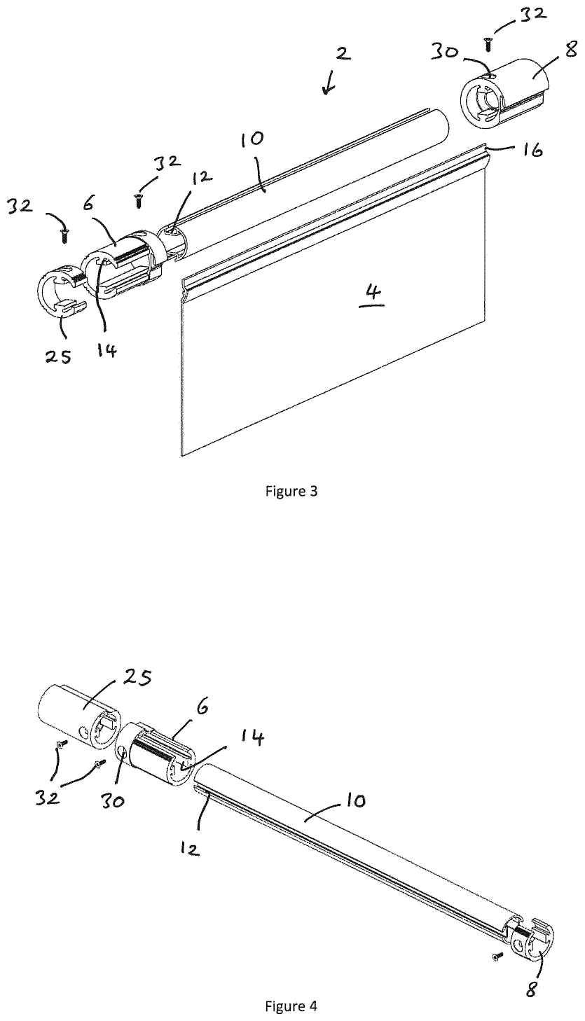

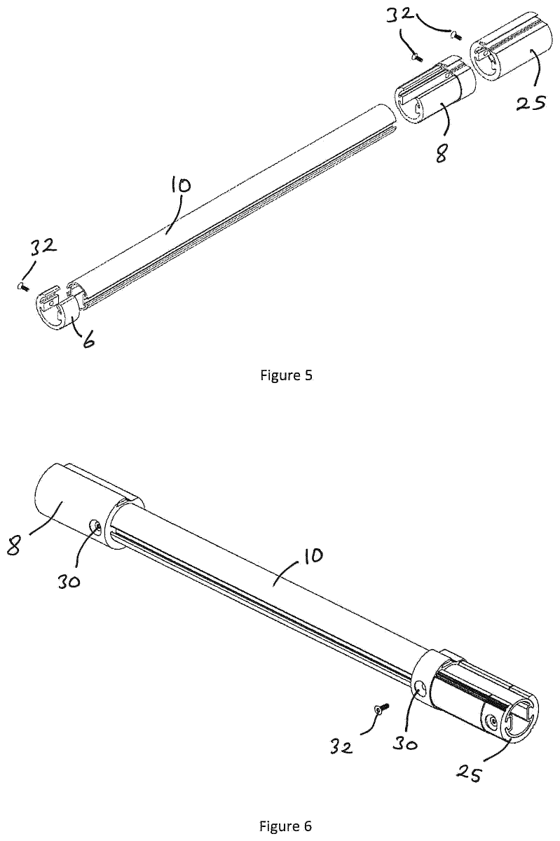

The screen 4 is releasably attached to the roller 2 by a fastening device comprising cooperating first and second fastening components. As best shown in FIG. 3, the first fastening component may comprise an elongate strip 16 attached to the upper marginal edge of the screen 4, the second fastening component comprising an elongate receiving slot 18 integrally formed in the outer surface of both the first and second roller sections 6,8 of the roller 2 within which the elongate strip 16 is received, the elongate strip 16 and receiving slot 18 being shaped to engage one another to attach the screen 4 to the roller 2, while being readily separable from one another to allow removal and replacement of the screen 4 from the roller 2.

The shape and dimensions of the elongate strip 16 and elongate receiving slot 18 are such that, in use, when the strip 16 is inserted into the receiving slot 18 to secure the screen 4 to the roller 2, the resulting assembly presents a circular cross section of substantially constant radius. More particularly, the elongate strip 16 also serves to reinforce the roller 2 when inserted into the receiving slot 18, bridging the gap between the first and second roller sections 6,8, to provide support for the screen 4 over the exposed portion of the intermediate roller section 10 when wound onto the roller 2, reducing drooping and wrinkling of the screen material as it is wound onto the roller, while still permitting the length of the roller 2 to be readily adjusted to suit the width of the window opening into which the screen assembly is to be installed. Preferably the elongate strip 16 is formed from a substantially rigid material that resists bending, for example rigid plastic or a metal, such that the screen is supported by the elongate strip over the exposed portion of the intermediate roller section 10 when wound onto the roller 2.

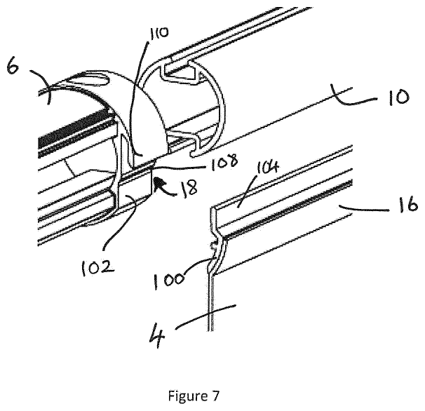

As best illustrated in FIG. 7, the elongate receiving slot 18 extends substantially tangentially to the outer surface of the roller 2 for receiving a least a portion of said elongate strip 16. The elongate strip 16 comprises a base portion 100 adapted to overlie a seat 102 defined by the outer surface of the first and second roller sections adjacent the receiving slot and a terminal portion 104 shaped to be received within the receiving slot 18 of the roller 2, the base portion 100 having a curved outer face defining a continuation of the outer surface of the roller 2. A ridge 106 projects from an inner face of the base portion 100 to engage a channel 108 formed in said seat 102 to retain the elongate strip 16 within the receiving slot 18 in snap fit manner when inserted therein. A portion of said receiving slot 18 is defined by a lip 110, such that at said terminal portion 104 of the strip 16 can be received beneath said lip 110. An outer face of said lip 110 defines a portion of the outer surface of the roller 2.

The upper edge region of the screen 4 may be adhered or otherwise secured to an outer face of the strip 16.

This arrangement enables the screen 4 to be readily removed from the roller 2 for cleaning and allows the screen to be replaced or interchanged. Thus the appearance of the roller blind assembly can be easily, quickly and cheaply altered by simply interchanging the screen 4 with one of a different colour or pattern. In addition, the screen 4 may be replaced by other types of screen, such a roman blind having pleated portions, providing even greater flexibility. This arrangement also enables the roller 2 and mounting brackets to be fitted to a window, adjusting the length of the roller 2 to suit the width of the window opening, prior to fitting the screen 4 and enables the screen 4 to be ordered to suit the width of the roller/window opening once the roller 2 and mounting brackets have been fitted to the window opening.

Markings may be provided on the outer surfaces of the first, second and/or intermediate roller sections 6,8,10 to allow the length of the roller 2 to be readily determined therefrom.

As shown in the drawings, radially extending holes 30 may be provided adjacent inner ends of the first and second roller sections through which screws 32 may be inserted to engage the intermediate section 10 to lock the first, second and intermediate sections 6,8,10 together.

In use, the mounting brackets are attached to the sides of a window opening in which the roller blind assembly is to be fitted and the roller 2 is extended by sliding the first and second roller sections 6,8 away from one another until the ends of the roller 2 engage the brackets. Screws 32 can then be inserted through the holes 30 in the first and second roller sections 6,8 to engage the intermediate section 10 to fix the length of the roller 2.

The extended overall length of the roller is then determined and the screen can then either cut to size by the installer or a screen of the required width to suit the measured length of the roller can be supplied by the manufacturer. For example, the desired screen of the measured width can be ordered via a website. The screen 4 can then be readily attached to the roller 2 by inserting the elongate strip 16 provided on an upper end of the screen into the receiving slot 18 provided on the first and second sections of the roller 2.

In an alternative embodiment, to provide greater resistance to drooping or wrinkling of the screen 4 when wound over the exposed portion of the intermediate section 10 of the roller 2, an upper marginal portion of the screen to which the elongate strip 16 is attached may be formed from a material having a greater thickness and/or stiffness than the remainder of the screen 4. Said upper marginal portion may have a length substantially equal to the outer circumference of the roller 2 such that said upper marginal portion wraps at least once around the roller 2 as the screen 4 is wound onto the roller 2. The remainder of the screen 4 may be releasably attached to a lower marginal edge of said upper marginal portion of the screen 4.

The invention is not limited to the embodiment described herein but can be amended or modified without departing from the scope of the present invention as defined by the appended claims.

1. An adjustable width roller blind assembly comprising a roller having a longitudinal axis, a generally rectangular screen formed from a flexible sheet material having an upper marginal edge securable to the roller, wherein the roller comprises substantially cylindrical and axially aligned first and second roller sections, and an intermediate section located between and telescopically received within the first and second roller sections to permit adjustment of the length of the roller by adjusting the overlap between the first and second roller sections and the intermediate section, wherein the upper marginal edge of the screen is provided with a releasable fastening device adapted to releasably attach the screen to the first and second roller sections, said releaseable fastening device comprising a substantially rigid elongate member adapted to engage the first and second roller sections, bridging the gap therebetween by the intermediate section, when the screen is attached to the roller.

2. An assembly as claimed in claim 1, wherein the elongate member defining said fastening device is formed from a substantially rigid material that resists bending.

3. An assembly as claimed in claim 1, wherein the first and second sections of the roller are provided with an elongate slot or channel extending substantially over the entire length of the roller and parallel to the axis of the roller, said fastening device comprising an elongate strip receivable within said elongate slot or channel.

4. An assembly as claimed in claim 3, wherein said elongate slot or channel extends substantially tangentially to the outer surface of the first and second sections of the roller for receiving at least a portion of said elongate strip defining the fastening device.

5. An assembly as claimed in claim 3, wherein the shape and dimensions of the slot or channel and that of the elongate strip are such that, in use, when the elongate strip defining the fastening device is inserted into the slot or channel to secure the screen to the roller, the resulting assembly presents a circular cross section of substantially constant radius.

6. An assembly as claimed in claim 5, wherein said elongate strip defining the fastening device comprises a base portion adapted to lie against or within a seat formed in the outer surface of both the first and second roller sections adjacent said slot or channel and a terminal portion shaped to be received within the elongate slot or channel of the first and second roller sections, the base portion having a curved outer face defining a continuation of the outer surface of the roller.

7. An assembly as claimed in claim 6, wherein a portion of said slot or channel is defined by a lip extending in a direction substantially tangential to the outer surface of the first and second roller sections, such that said terminal portion of the fastening device can be received beneath said lip.

8. An assembly as claimed in claim 7, wherein an outer face of said lip defines a portion of the outer surface of the roller.

9. An assembly as claimed in claim 6, wherein one of said seat formed in the outer surface of both the first and second roller sections and said elongate strip includes a recess and the other of said seat and said elongate strip includes a projection cooperating with said recess to retain the elongate strip defining the fastening device within the slot or channel.

10. An assembly as claimed in claim 1, wherein said first, second and/or intermediate sections of the roller are provided with markings to enable the overall length of the roller to be determined therefrom.

11. An assembly as claimed in claim 1, wherein said first and second sections of the roller incorporate formations engaging cooperating formations on the intermediate section to prevent rotation of the first and second sections with respect to the intermediate section and thereby with each other.

12. An assembly as claimed in claim 11, wherein said cooperating formations comprise at least one elongate channel formed in an outer surface of the intermediate section within which is received a cooperating ridge or projection extending from an inner surface of each of the first and second sections of the roller.

13. An assembly as claimed in claim 1, wherein a locking device is provided for locking the positions of the first and second roller sections with respect to the intermediate section to fix the length of the roller.

14. An assembly as claimed in claim 13, wherein said locking device comprises one or more radial apertures formed in the first and second roller sections and fasteners insertable through said radial apertures to engage the intermediate section.

15. An assembly as claimed in claim 14, wherein said fasteners comprise self tapping screws.

16. An assembly as claimed in claim 1, wherein an upper marginal portion of the screen is formed from a material having a greater thickness and/or stiffness than the remainder of the screen, said releasable fastening device by which the screen is attached to the roller being provided on said upper marginal portion of the screen.

17. An assembly as claimed in claim 16, wherein said upper marginal portion of the screen has a length substantially equal to or greater than the outer circumference of the roller such that said upper marginal portion wraps at least once around the roller as the screen is wound onto the roller.

18. An assembly as claimed in claim 16, wherein the remainder of the screen is releasably attached to a lower marginal edge of said upper marginal portion of the screen.

19. A method of installing a roller blind assembly as claimed in claim 1 to a window opening comprising the steps of fitting first and second mounting brackets to either side of the window opening, extending the first and second roller sections of the roller away from each other until the ends of the roller engage the first and second mounting brackets, providing a screen wherein an upper marginal edge of the screen is provided with a releasable fastening device for releasably attaching the screen to the first and second roller sections and having a width substantially equal to the extended length of the roller and attaching the releasable fastening device of the screen to the roller.

20. A method as claimed in claim 19, further comprising the step of locking the first and second roller sections to the intermediate section to fix the length of the roller prior to attaching the screen thereto.

21. A method as claimed in claim 19, wherein the releasable fastening device bridges a gap between the first and second roller sections to support the screen when it is wound onto the roller.
